(19) United States
(12) Patent Application Publication
(10) Pub. No.: US 2017/0364697 A1
(43) Pub. Date: Dec. 21, 2017

(54) DATA INTERWORKING METHOD AND DATA INTERWORKING DEVICE

(71) Applicant: Tencent Technology (Shenzhen) Company Limited, Shenzhen (CN)

(72) Inventors: Ji Zhao, Shenzhen (CN); Kaibin Chen, Shenzhen (CN)

(21) Appl. No.: 15/674,411

(22) Filed: Aug. 10, 2017

Related U.S. Application Data
(63) Continuation of application No. PCT/CN2015/100161, filed on Dec. 31, 2015.

(30) Foreign Application Priority Data
Feb. 12, 2015 (CN) 201510075321.2

(51) Int. Cl. G06F 21/62; G06F 17/30

(52) U.S. Cl. CPC G06F 21/6218; G06F 17/30525; G06F 17/30545

(57) ABSTRACT

A data interworking method and a data interworking device are provided. The implementation of the method comprises: receiving first data and second data, wherein the first data are associated with a first user identity of a first platform, and the second data are associated with a second user identity of a second platform; generating a uniform user identity of a user corresponding to the first user identity and/or the second user identity in response to a request of the user, and obtaining result data corresponding to the uniform user identity of the user according to the first data and the second data; and storing the result data and the uniform user identity. The method can realize data interworking of associated users under account number systems of different platforms so as to realize data fusion.

### CROSS REFERENCE TO RELATED APPLICATION

This application is a continuation of International Application No. PCT/CN2015/100161, filed on Dec. 31, 2015, which claims the priority to Chinese Patent Disclosure No. 201510075321.2, titled “DATA INTERWORKING METHOD AND DATA INTERWORKING DEVICE”, filed on Feb. 12, 2015, both of which are hereby incorporated by reference in their entireties.

### TECHNICAL FIELD

The present disclosure relates to a field of communications technology, and in particular to a data interworking method and a data interworking device.

### BACKGROUND

Data interworking is sharing data of a server.

Currently, a technology solution for data interworking is to connect data of a platform with a same background server and to perform data fusion based on uniqueness of the background. For example, solutions of microblog or other social media.

Such a solution is characterized in that different user identities (Identity, ID) are allocated for different account systems, and there is no association between different user IDs.

Following technical problems exist in the solution. When an external account system is used as a login method, association of the same user in different systems cannot be obtained for a fusion. In addition, when different platforms are used for access, due to restrictions on certain platform, data of the same account in different platforms cannot be fused.

### SUMMARY

A data interworking method and a data interworking device are provided according to an embodiment of the present disclosure, which can realize data interworking of associated users under account systems of different platforms so as to realize data fusion.

A data interworking method includes:

receiving first data and second data, where the first data are associated with a first user identity of a first platform, and the second data are associated with a second user identity of a second platform;

generating a unified user identity of a user corresponding to the first user identity and/or the second user identity in response to a request of the user, and obtaining result data corresponding to the unified user identity of the user according to the first data and the second data in a case that the first user identity and the second user identity are associated with each other; and

storing the result data and the unified user identity, where the unified user identity is a user identity which is associated with the first user identity and the second user identity.

A data interworking device includes: a memory and one or more processors, wherein the memory stores program instructions, and the processor is configured to execute the program instructions to:

receive first data and second data, where the first data are associated with a first user identity of a first platform, and the second data are associated with a second user identity of a second platform;

generate a unified user identity of a user corresponding to the first user identity and/or the second user identity in response to a request of the user, and obtain result data corresponding to the unified user identity of the user according to the first data and the second data; and

store the result data and the unified user identity.

As can be seen from the technical solutions, embodiments of the present disclosure have the following advantages. According to the embodiments of the present disclosure, after the first data and the second data are respectively received from the first platform and the second platform, data of different user identities are calculated to realize data fusion and stored in a unified user identity. Then data interworking of associated users under account systems of different platforms can be realized so as to realize data fusion.

### BRIEF DESCRIPTION OF THE DRAWINGS

The accompany drawings needed to be used in the description of the embodiments are described briefly as follows, so that the technical solutions according to the embodiments in the present disclosure become clearer. It is obvious that the accompany drawings in the following description are only some embodiments of the present disclosure. For those skilled in the art, other accompany drawings may be obtained according to these accompany drawings without any creative work.

FIG. 1 is a flow chart of a method according to embodiment of the present disclosure;

FIG. 2 is a schematic diagram of a system architecture according to an embodiment of the present disclosure;

FIG. 3 is a schematic diagram of a system architecture according to an embodiment of the present disclosure;

FIG. 4 is a schematic structural diagram of a data interworking device according to an embodiment of the present disclosure;

FIG. 5 is a schematic structural diagram of a data interworking device according to an embodiment of the present disclosure;

FIG. 6 is a schematic structural diagram of a data interworking device according to an embodiment of the present disclosure;

FIG. 7 is a schematic structural diagram of a data interworking device according to an embodiment of the present disclosure;

FIG. 8 is a schematic structural diagram of a data interworking device according to an embodiment of the present disclosure; and

FIG. 9 is a schematic structural diagram of a data server according to an embodiment of the present disclosure.

### DETAILED DESCRIPTION OF THE EMBODIMENTS

The present disclosure will be described in detail as follows in conjunction with the accompany drawings, to clarify the purpose, solutions and advantages of the present disclosure more clearly. It is obvious that the described embodiments are only a part of the embodiments according to the present disclosure, not all embodiments thereof. All the other embodiments obtained by those skilled in the art based on the embodiments in the present disclosure without any creative work belong to the scope of the present disclosure.

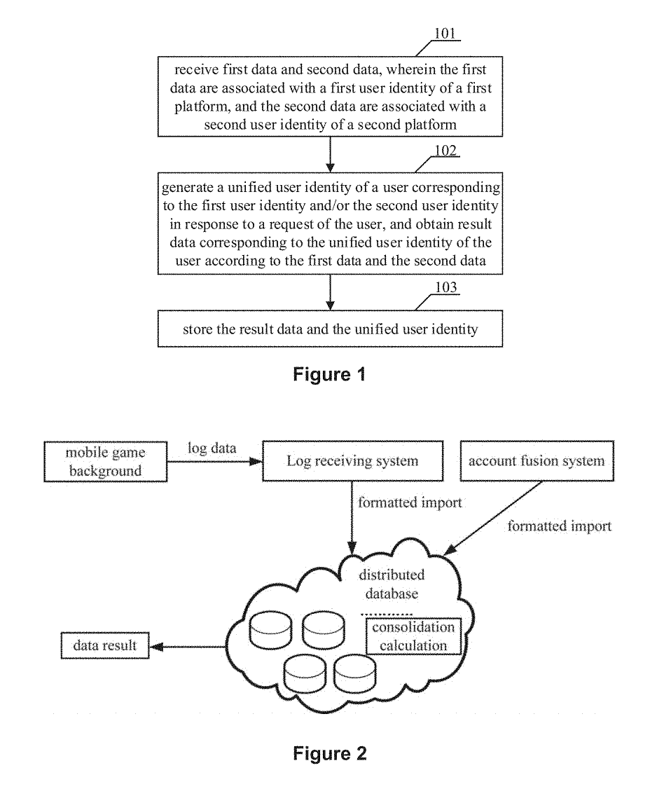

A data interworking method is provided according to an embodiment of the present disclosure, as shown in FIG. 1, which includes steps 101 to 103.

In step 101, first data and second data are received. The first data are associated with a first user identity of a first platform, and the second data are associated with a second user identity of a second platform.

For example, the receiving the first data and the second data may be receiving first data and second data of a user, who is active in DAU (Daily Active User), from a server, thereby improving data scalability and avoiding performance problems caused by excessive resource occupation. An example of the first data and the second data is data associated with the first user identity and data associated with the second user identity in a log (e.g., a log of an active user in DAU). In other embodiments, the first data and the second data may also be obtained from, such as, a relational database, a non-relational database, a data dictionary, and a network protocol.

The first platform and the second platform may be two different platforms running in a client device. A user may access a server through the first or second platform of the client, and the server generates data for recording user behavior, that is, the log. For example, the first platform and the second platform may be different application programs, or a same application program running in different operating systems. The first user identity may be a user account in the first platform. The second user identity may be a user account in the second platform. The two accounts may be accounts of a same user, or accounts of different users.

If the first user identity and the second user identity are the accounts of the same user (that is, the first user identity and the second user identity correspond to the same user), it may be known that the two user identities are associated with each other. If the first user identity and the second user identity are not accounts of the same user (that is, the first user identity and the second user identity correspond to different users), it may be known that the two user identities are not associated. Each of the first data and the second data are data corresponding to a user identity. Each of the first data and the second data may include at least one of a platform type, an account type, a mode, a mode value, a grade and a data statistics date. A specific content of the first data and the second data may be determined as required, which is not limited herein.

It should be noted that ‘the first’ and ‘the second’ are only configured to distinguish two platforms, accounts and corresponding data contents, which do not have other limiting meanings and do not mean that there are only two types of platforms. In practice, there may be multiple platform types. Therefore, ‘the first’ and ‘the second’ should not be construed as limiting quantity.

In step 102, in response to a request of a user corresponding to the first user identity and/or the second user identity, a unified user identity of the user is generated. And according to the first data and the second data, result data corresponding to the unified user identity of the user is obtained.

It is noted that, data corresponding to the unified user identity of the user is referred to as the result data only for distinguishing from the first data and the second data, and the result data may also be referred to as third data.

If a user making a request corresponds to both the first user identity and the second user identity, it means that the first user identity and the second user identity are associated with each other. Then the unified user identity is generated instead of the first user identity and the second user identity, and obtaining methods of the result data may include:

taking a larger value of the first data and the second data as the result data corresponding to the unified user identity of the user; or

taking a sum of the first data and the second data as the result data corresponding to the unified user identity of the user.

The result data are data that needs to be used finally, so a calculation method may formulate a corresponding strategy as required. For example, when a ranking is needed, the larger value of the first data and the second data is taken as the result data, such as, a grade or a score of a game; or the sum of the first data and the second data is taken as the result data, for example, consumption amount may be the larger value or the sum. Since the calculation method may formulate the corresponding strategy as required, embodiments of the present disclosure do not limit to the calculation strategy.

If the user making the request only corresponds to the first user identity or the second user identity, it means that the first user identity and the second user identity are not associated with each other. Then the obtaining methods of the result data may include the followings. If the user making the request only corresponds to the first user identity, the first data are determined as the result data corresponding to the unified user identity of the user. And if the user making the request only corresponds to the second user identity, the second data are determined as the result data corresponding to the unified user identity of the user.

According to some embodiments of the present disclosure, if the user making the request only corresponds to the first user identity, the unified user identity of the user is the first user identity. And if the user making the request only corresponds to the second user identity, the unified user identity of the user is the second user identity.

In step 103, the result data and the unified user identity are stored.

The result data and the unified user identity may be stored using a distributed database every predetermined time period. It is noted that a storage using the distributed database is only an alternative storage way. According to some embodiments of the present disclosure, the result data and the unified user identity may be stored in other ways, such as a general relational database, a disk file, memory data, Map-Reduce data, cloud storage data, or any other data storage methods.

For example according to some embodiments of the present disclosure, the result data and the unified user identity may be stored in a data structure with a fixed format. Data items of the data structure includes: a unified user identity, a platform type, a first user identity, a second user identity, data associated with a user identity existed in the data structure, and/or reporting time of the data. The data associated with the user identity may include the first data associated with the first user identity, the second data associated with the second user identity, and the result data (and a type of the result data) associated with the unified user identity. According to some embodiments of the present disclosure, the data structure can not only store the data items, but also indicate an association between the stored data items, that is, the data structure can store the data items in association with each other.

According to some embodiments of the present disclosure, the data structure may be constructed before the result data are obtained. Then the received first data and the received second data may be cached before the result data are obtained.

According to some embodiments of the present disclosure, the data items of the data structure may be extended as required.

According to an embodiment of the present disclosure, after the first data associated with the first user identity of the first platform and the second data associated with the second user identity of the second platform are received, the result data are calculated for data of different user identities to realize data fusion, and the result data and the unified user identity are stored in association with each other. Then data interworking of associated users under account systems of different platforms can be realized so as to realize data fusion. After the result data and the unified user identity are stored, stored contents may be applied to multiple purposes. According to sonic embodiments of the present disclosure, a specific application scene in applications with sorting requirements is given. Specifically, after the result data and the unified user identity are stored, the method further includes:

obtaining group account information, where the group account information includes at least two user identities;

determining a unified user identity corresponding to each of user identities in the group account information, and determining result data corresponding to each of unified user identities; and

sorting the user identities in the group account information according to the result data corresponding to each of unified user identities.

A solution of the embodiment may be applied to a user ranking in a game. The ranking is different in response to different result data, such as, a grade ranking, a score ranking and a consumption amount ranking.

The group account information of the embodiment may be obtained in a form of an account list. After the account list is obtained, the unified user identity may be first determined, and then the corresponding result data are obtained. An obtaining method of the result data is described as follows. The determining the result data corresponding to each of unified user identities includes:

obtaining the result data corresponding to each of unified user identities from a database according to the unified user identity corresponding to each of user identities.

According to some embodiments of the present disclosure, after the data are stored, a query service of the data may be realized. A query solution is described in detail as follows. After the result data and the unified user identities are stored, the method further includes:

receiving a query request which includes the unified user identity, the first user identity, the second user identity or a data item type of the result data; and

querying a database storing the result data and the unified user identities according to the query request, and determining a query result.

A technical problem to be solved in the embodiment of the present disclosure is to solve the problem of data interworking of a user under different platforms and different account systems. A mobile game is taken as an example, to describe the embodiment of the present disclosure in detail. As shown in FIG. 2, a system framework is mainly divided into three parts, which includes a log receiving system, an account fusion system and a distributed database system.

1. The Log Receiving System

The log receiving system is responsible for receiving log data generated and sent by a mobile game background, and forming a file list (or other form) of the log data for temporary storage. After the temporary storage of the log data, the log data are imported into a distributed database based on a certain time strategy (optionally a timing strategy) in a formatted way.

The log receiving system may include a server program, a client program and a storage device.

The server program is responsible for receiving the log data sent by the mobile game background. After being received, the log data are written to a disk in a certain form (optionally a log time-shared file).

When the time strategy is triggered effectively, the log receiving system, through the client program in a certain method and format, writes the log data to a storage device of the distributed database system.

Since the log is generated by the mobile game background, data of different platforms and different account systems are connected to a same mobile game background, which provides necessary conditions for data interworking. A format of the log is recommended as follows:

(user account type|user account|user platform typed user game data)

2. The Account Fusion System

The account fusion system is responsible for fusing different account systems and different platforms into a same account system, and importing a fused result into a distributed database based on a certain time strategy (optionally a timing strategy) in a formatted way.

The account fusion system may include a server program, a client program and an account correspondence storage structure (optionally an account binding database).

Under a trigger of a user operation, the server program of the account fusion system binds accounts under different account systems to a fusion account, and stores the binding relationship to the account correspondence storage structure.

When the time strategy is triggered effectively, the account fusion system, through the client program in a certain method and format, writes data to a storage device of the distributed database system.

The account fusion system saves a relationship between accounts of different account systems, which provides necessary conditions for data interworking under different account systems. A single record format of the account correspondence storage structure is recommended as follows:

(fused account) binding account under system 1|binding account under system 2| . . . . . . |binding account under system n)

3. The Distributed Database System

The distributed database system is mainly responsible for converting the log data into a unified or configurable storage format for permanent storage. And, a script and a storage procedure may be defined as a calculation tool, a data consolidation calculation is performed according to a certain time and business strategy. Data results after the consolidation calculation are outputted in a certain form, for the mobile game background statistics and display, or to be provided to a third party.

The implementation of the consolidation calculation may be described as follows. According to the structure of the log and the structure of account correspondence, final interworking data may be calculated. A calculation method needs to be carried out based on specific requirements of the business. A recommended method is to take the game data result with a largest measurement index when there are records of different platforms or different account system in a same fusion account.

The result may be outputted as follows: the data result of the consolidation calculation needs to be saved in a specific location, or may also be stored directly in the distributed database system. A recommended method is to use scripts and configuration files to output to the result database or the results file for later use.

It should be noted that an application scene of the embodiment of the present disclosure may also have other forms in addition to the mobile game, such as, a mobile application software, a PC (personal computer) application software, a software supported by an intelligent device or other hardware devices, and any other scenes involving data interworking.

An information carrier is not necessarily a log, and may also have other forms, such as relational database record storage, non-relational database storage, a data dictionary, a network protocol, or any other methods that may indicate data.

Data storage is not necessarily a distributed database, and may also have other forms, such as, a general relational database, a disk file, memory data, Map-Reduce data, cloud storage data, or any other data storage methods.

Based on the above description, the embodiment of the present disclosure takes the mobile game, the log and the distributed database as an example, which is not to be construed as limiting the uniqueness of embodiments of the present disclosure.

In the solution, game data under different game platforms and different account systems may be broken through. For example, game contents such as equipments, props, gold coins, recharging information of Android (Android) and iOS (iPhone Operating System) are broken through, to solve the problem that players in different platforms and different regions cannot compete. Through a community to get together the players, firstly all mobile game gods are gathered in a platform, so that an association of world-class mobile game communities becomes possible.

A system provided by an embodiment of the present disclosure, such as a Tencent Mobile Game Center, has the following functions.

(1) Based on an active user list on a Mobile Game Center, user game data are calculated regularly.

(2) A unified external interface and service are added for a game behavior data system.

(3) A problem of a slow calculation speed and an uncontrolled ex-warehouse data scale is optimized.

Based on the functions, a solution provided according to an embodiment of the present disclosure is described as follows.

1. The Active User List on the Mobile Game Center is Obtained.

An active user log of the Mobile Game Center is recorded in a reporting command word of a current DAU (Daily Active User) and warehoused by the day, thereby avoiding performance problems caused by excessive resource occupation and improving the data scalability. Only a Mobile Game Center ID of the active user is recorded in the log.

A warehoused target list may include fields: (a Mobile Game Center ID, a corresponding account type, a corresponding account, reporting time). And for the corresponding account type, 0 may indicate a QQ number, and 1 may indicate a WeChat commID.

In addition, the database may be maintained for removing invalid data, specifically as follows: removing data, whose reporting time was one-month ahead of a current warehouse time, from a list.

Every day the active user list is warehoused into a Tencent distributed data warehouse (Tencent distributed Data Warehouse, TDW), and calculated in the TDW. Then the problem of a slow speed for data ex-warehouse and an uncontrolled ex-warehouse data scale can be solved.

2. A TDW Data Calculation

Currently, a data format of 8 accessed games is as follows:

(dtstatdate, gameid, accounttype, openid, uin, modetype, modevalue, amount, level), parameters are respectively data statistics date, game account, account type, open identity, UAN code (Universal Internet Number), mode, mode value, quantity, and level.

A data format of the calculation result is as follows:

(data, uid, gamePkgName, mode, modeValue), parameters are respectively data, identity, game name, mode, and mode value.

A calculation script is written in the TDW for calculating. A calculation result is written in a result table. And the result table is partitioned by date, and the ex-warehouse date is calculated according to the current date.

3. A Unified Service for Game Behavior Data

Ex-warehouse data needs to provide a unified external service for other services accessing. According to a current product logic, a service being accessed is only a community ranking service. An architecture of the service is designed below.

4. A Protocol Design

A current interface of the unified game service may be remained unchanged because of platform information. Data may be extended as the following structure:

enum ERegularMode {MODE_AMOUNT=10000, MODE_LEVEL=10001}

enum EStatisticType {STATISTIC_SUM=0, STATISTIC_AVERAGE=1}

struct TUserPlayGameModeValue

{0 require long uid;

1 require string gainePkgName;

2 require int mode;

3 require int modeValue;

4 optional int relatedPlatform;

};

interface XXXServant

{

//obtain user game behavior data

int getUserPlayGameModeValue(string gamePkgName, int mode, long uid, out TUserPlayGameModeValue userPlayGameModeValue);

//obtaining user game behavior data in batches

int getUserPlayGarneModeValue(string gamePkgName, int mode, vector<long>uidList, out map<long, TUserPlayGameModeValue>userPlayGameModeValueBatchResult);

//obtain a user game behavior data ranking based on a user list

int getGameModeValueSortByUidList(string gamePkgName, int mode, vector<long>uidList, out vector<TUserPlayGameModeValue>resultSorthist);

//obtain user game behavior statistical data based on a user list

int getGameModeValueStatisticByUidList(string gamePkgName, int mode, vector<long>uidList, out map<int, int>statisticResult),

};

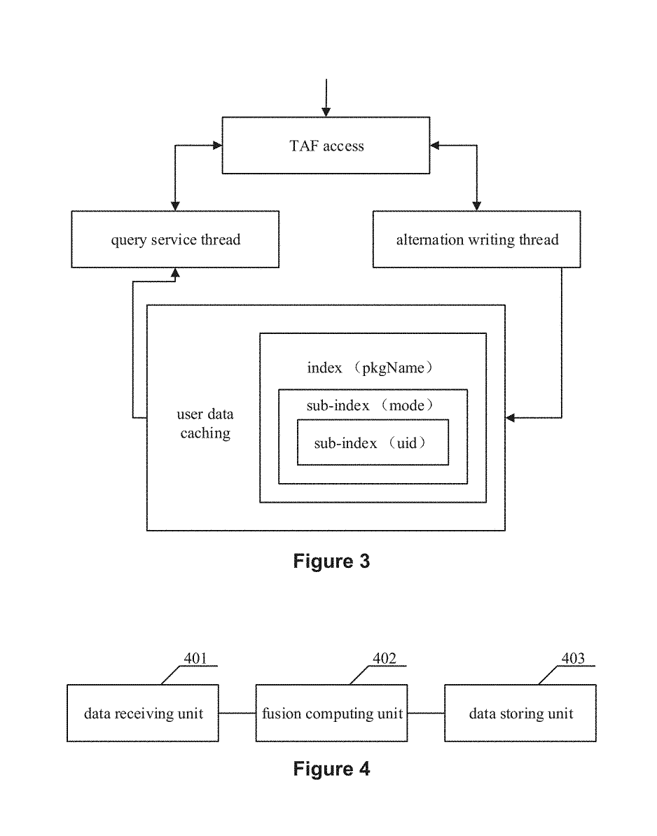

The embodiment of the present disclosure also provides an architecture diagram about a query service and a related application for altering a database in the foregoing embodiment, as shown in FIG. 3, which mainly includes: a TAF (Test Automation Framework) access, a query service thread, an alternation writing thread and a user data caching.

The TAF access provides an external interface,

The query service thread realizes a query for user data caching.

The alternation writing thread realizes a rewriting operation for user data caching.

The user data caching stores user data, which is mainly the user reporting data and/or the consolidated result data. The data may include an index (pkgName), a sub-index (mode) and a subordinate sub-index (uid) of a sub-index. It is not intended to limit embodiments of the present disclosure to a specific data caching form.

In the architecture diagram, if other games are accessed later, a corresponding index may be increased in the user data caching. If there is a query based on the user Mobile Game Center ID, indexes are traversed.

If there is a later query based on date, a data index is added above the sub-index mode or peer, and indexes are traversed for query.

A data interworking device is provided according to an embodiment of the present disclosure, as shown in FIG. 4, and the device includes a data receiving unit 401, a fusion computing unit 402 and a data storing unit 403.

The data receiving unit 401 is configured to receive first data and second data. And the first data are associated with a first user identity of a first platform, and the second data are associated with a second user identity of a second platform.

The fusion computing unit 402 is configured to generate a unified user identity of a user corresponding to the first user identity and/or the second user identity in response to a request of the user, and obtain result data corresponding to the unified user identity of the user according to the first data and the second data

The data storing unit 403 is configured to store the result data and the unified user identity.

The first platform and the second platform are two different platforms. The first user identity may be a user account in the first platform. The second user identity may be a user account in the second platform. The two accounts may be accounts of a same user, or accounts of different users. If the first user identity and the second user identity are the accounts of the same user, the two user identities are associated with each other.

The first data and the second data are data corresponding to user identities, which may include at least one of a platform type, an account type, a mode, a mode value, a grade and a data statistics date. A specific content of the first data and the second data may be determined as required, which is not limited herein.

It should be noted that ‘the first’ and ‘the second’ are only configured to distinguish two platforms, accounts and corresponding data contents, which do not have other limiting meanings and do not mean that there are only two types of platforms. In practice, there may be multiple platform types. Therefore, ‘the first’ and ‘the second’ should not be construed as limiting quantity.

According to an embodiment of the present disclosure, after the first data associated with the first user identity of the first platform and the second data associated with the second user identity of the second platform are received, the result data are calculated for data of different user identities to realize data fusion, and the result data and the unified user identity are stored in association with each other. Then data interworking of associated users under account systems of different platforms can be realized so as to realize data fusion.

In a case that the first user identity and the second user identity are not associated with each other according to an embodiment of the present disclosure, the fusion computing unit 402 is further configured to:

determine the first data as the result data corresponding to the unified user identity of the user in a case that a user making a request only corresponds to the first user identity; and

determine the second data as the result data corresponding to the unified user identity of the user in a case that the user making the request only corresponds to the second user identity.

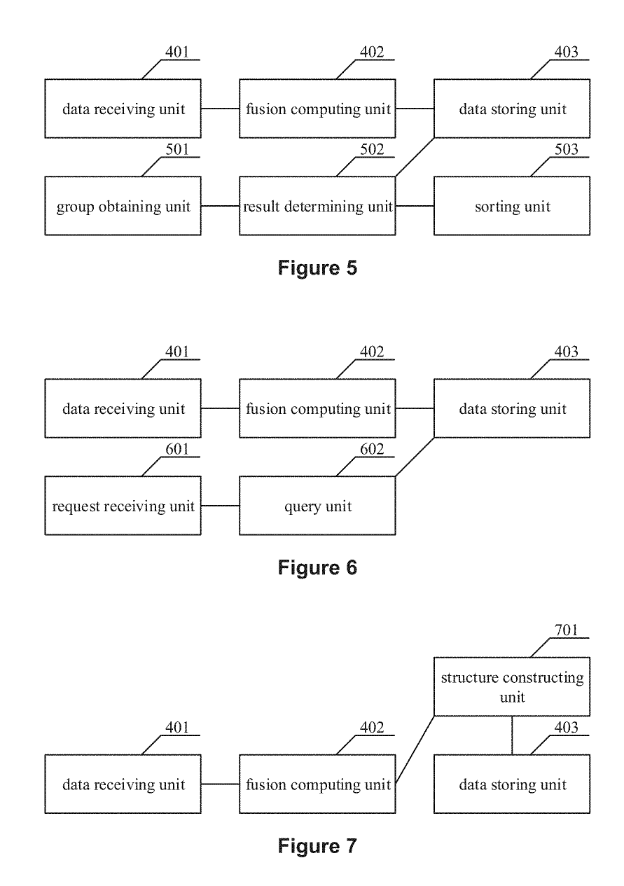

Further, after the result data and the unified user identity are stored, stored contents may be applied to multiple purposes. According to some embodiments of the present disclosure, a specific application scene in applications with sorting requirements is given. Specifically, as shown in FIG. 5, the data interworking device further includes a group obtaining unit 501, a result determining unit 502 and a sorting unit 503.

The group obtaining unit 501 is configured to obtain group account information after storing the result data and the unified user identities. And the group account information includes at least two user identities.

The result determining unit 502 is configured to determine a unified user identity corresponding to each of user identities in the group account information, and determine result data corresponding to each of unified user identities.

The sorting unit 503 is configured to sort the user identities in the group account information according to the result data corresponding to each of unified user identities.

A solution of the embodiment may be applied to a user ranking in a game circle. The rankings are different in response to different result data, such as, a grade ranking, a score ranking and a consumption amount ranking.

Optionally, the group account information of the embodiment may be obtained in a form of an account list. After the account list is obtained, the unified user identity may be first determined, and then the corresponding result data are obtained. An obtaining method of the result data is described as follows. The result determining unit 502 is specifically configured to obtain result data corresponding to each of unified user identities from a database according to the unified user identity corresponding to each of user identities.

According to some embodiments of the present disclosure, after the data are stored, a query service of the data may be realized. A query solution is described in detail as follows. As shown in FIG. 6, the data interworking device further includes a request receiving unit 601 and a query unit 602.

The request receiving unit 601 is configured to receive a query request after storing the result data and the unified user identities. And the query request includes the unified user identity, the first user identity, the second user identity or a data item type of the result data.

The query unit 602 is configured to query a database storing the result data and the unified user identities according to the query request, and determine a query result.

According to an embodiment of the present disclosure, the result data are data that needs to be used finally, so a calculation method may formulate a corresponding strategy as required. For example, when a ranking is needed, the larger value of the first data and the second data is taken as the result data, such as, a grade or a score of a game. Or the sum of the first data and the second data is taken as the result data, for example, consumption amount may be the larger value or the sum. Since the calculation method may formulate the corresponding strategy as required, embodiments of the present disclosure do not limit the calculation strategy.

According to some embodiments of the present disclosure, the fusion computing unit 402 is configured to take a larger value of the first data and the second data as the result data corresponding to the unified user identity of the user, or take a sum of the first data and the second data as the result data corresponding to the unified user identity of the user, in a case that a user making a request corresponds to both the first user identity and the second user identity.

For example, according to some embodiments of the present disclosure, the result data and the unified user identity may be stored in a data structure with a fixed format. For example, as shown in FIG. 7, the data interworking device further includes a structure constructing unit 701.

The structure constructing unit 701 is configured to construct a data structure. Data items of the data structure includes: a unified user identity, a platform type, a first user identity, a second user identity, data associated with a user identity existed in the data structure, and/or reporting time of the data. The data associated with a user identity may include first data associated with a first user identity, second data associated with a second user identity, and result data (a type of the result data) associated with a unified user identity. According to some embodiments of the present disclosure, the data structure can not only store the data items, but also indicate an association between the stored data items. Or the data structure can store the data items in association with each other.

According to some embodiments of the present disclosure, the data structure may be constructed before the result data are obtained. Then the received first data and the received second data may be cached before the result data are obtained. According to some embodiments of the present disclosure, the data items of the data structure may be extended as required.

Optionally, the data storing unit 403 is configured to store the result data and the unified user identity in a distributed database every predetermined time period. It is noted that a storage of the distributed database is only an alternative storage way. According to some embodiments of the present disclosure, the result data and the unified user identity may be stored in other ways, such as a general relational database, a disk file, memory data, Map-Reduce data, cloud storage data, or any other data storage methods.

The receiving the first data and the second data may be receiving first data and second data of a user, who is active in DAU (Daily Active User), thereby improving the data scalability and avoiding performance problems caused by excessive resource occupation. According to some embodiments of the present disclosure, the data receiving unit 401 is configured to receive a log of a user, who is active in daily active user DAU. The log includes the first data and the second data.

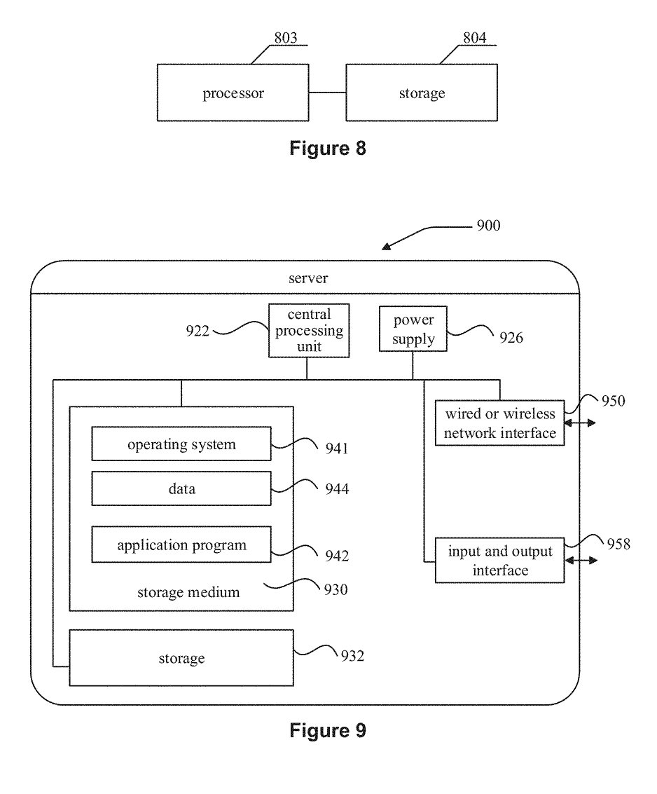

Another data interworking device is provided according to an embodiment of the present disclosure, as shown in FIG. 8, and the device includes a processor 803 and a storage 804.

When executing program instructions stored in a storage, the processor 803 is configured to receive first data and second data, where the first data are associated with a first user identity of a first platform, and the second data are associated with a second user identity of a second platform; generate a unified user identity of a user corresponding to the first user identity and/or the second user identity in response to a request of the user, and obtain result data corresponding to the unified user identity of the user according to the first data and the second data; and store the result data and the unified user identity.

The first platform and the second platform are two different platforms. The first user identity may be a user account in the first platform. The second user identity may be a user account in the second platform. The two accounts may be accounts of a same user, or accounts of different users. If the first user identity and the second user identity are the accounts of the same user, the two user identities are associated with each other.

The first data and the second data are data corresponding to a user identity, which may include at least one of a platform type, an account type, a mode, a mode value, a grade and a data statistics date. A specific content of the first data and the second data may be determined as required, which is not limited herein.

It should be noted that ‘the first’ and ‘the second’ are only configured to distinguish two platforms, accounts and corresponding data contents, which do not have other limiting meanings and do not mean that there are only two types of platforms. In practice, there may be multiple platform types. Therefore, ‘the first’ and ‘the second’ should not be construed as limiting quantity.

According to an embodiment of the present disclosure, after the first data associated with the first user identity of the first platform and the second data associated with the second user identity of the second platform are received, the result data are calculated for data of different user identities to realize data fusion, and the result data and the unified user identity are stored in association with each other. Then data interworking of associated users under account systems of different platforms can be realized so as to realize data fusion.

The receiving the first data and the second data may be receiving first data and second data of a user, who is active in DAU (Daily Active User), thereby improving the data scalability and avoiding performance problems caused by excessive resource occupation. According to some embodiments of the present disclosure, the processor 803 is configured to receive a log of a user, who is active in daily active user DAU. The log includes the first data and the second data.

According to an embodiment of the present disclosure, the result data are data that needs to be used finally, so a calculation method may formulate a corresponding strategy as required. For example, when a ranking is needed, the larger value of the first data and the second data is taken as the result data, such as, a grade or a score of a game. Or the sum of the first data and the second data is taken as the result data, for example, consumption amount may be the larger value or the sum. Since the calculation method may formulate the corresponding strategy as required, embodiments of the present disclosure do not limit the calculation strategy.

According to some embodiments of the present disclosure, the processor 803 is configured to take a larger value of the first data and the second data as the result data corresponding to the unified user identity of the user, or take a sum of the first data and the second data as the result data corresponding to the unified user identity of the user, in a case that a user making a request corresponds to both the first user identity and the second user identity.

In a case that the first user identity and the second user identity are not associated with each other according to an embodiment of the present disclosure, the processor 803 is further configured to:

determine the first data as the result data corresponding to the unified user identity of the user in a case that a user making a request only corresponds to the first user identity; and

determine the second data as the result data corresponding to the unified user identity of the user in a case that the user making the request only corresponds to the second user identity.

For example, according to some embodiments of the present disclosure, the result data and the unified user identity may be stored in a data structure with a fixed format. The processor 803 is further configured to construct a data structure. Data items of the data structure includes: a unified user identity, a platform type, a first user identity, a second user identity, data associated with a user identity existed in the data structure, and/or reporting time of the data. The data associated with a user identity may include first data associated with a first user identity, second data associated with a second user identity, and result data (a type of the result data) associated with a unified user identity. According to some embodiments of the present disclosure, the data structure can not only store the data items, but also indicate an association between the stored data items. Or the data structure can store the data items in association with each other.

According to some embodiments of the present disclosure, the data structure may be constructed before the result data are obtained. Then the received first data and the received second data may be cached before the result data are obtained.

According to some embodiments of the present disclosure, the data items of the data structure may be extended as required.

After the result data and the unified user identity are stored, stored contents may be applied to multiple purposes. According to some embodiments of the present disclosure, a specific application scene in applications with sorting requirements is given. Specifically, the processor 803 is further configured to:

obtain group account information after storing the result data and the unified user identities, where the group account information includes at least two user identities;

determine a unified user identity corresponding to each of user identities in the group account information, and determine result data corresponding to each of unified user identities; and

sort the user identities in the group account information according to the result data corresponding to each of unified user identities.

A solution of the embodiment may be applied to a user ranking in a game circle. The ranking is different in response to different result data, such as, a grade ranking, a score ranking and a consumption amount ranking.

The group account information of the embodiment may be obtained in a form of an account list. After the account list is obtained, the unified user identity may be first determined, and then the corresponding result data are obtained. An obtaining method of the result data is described as follows. The processor 803 is configured to obtain result data corresponding to each of unified user identities from a database according to the unified user identity corresponding to each of user identities.

According to some embodiments of the present disclosure, after the data are stored, a query service of the data may be realized. A query solution is described in detail as follows. The processor 803 is further configured to receive a query request after storing the result data and the unified user identities, where the query request includes the unified user identity, the first user identity, the second user identity or a data item type of the result data; and query a database storing the result data and the unified user identities according to the query request, and determine a query result.

According to some embodiments of the present disclosure, the processor 803 is configured to store the result data and the unified user identities in a distributed database every predetermined time period. It is noted that a usage of the distributed database is only an alternative storage way. And other storage ways may be selected according to some embodiments of the present disclosure, such as a general relational database, a disk file, memory data, Map-Reduce data, cloud storage data, or any other data storage methods.

The data interworking method and the data interworking device according to embodiments of the present disclosure may be realized based on a server. FIG. 9 is a schematic structural diagram of a server according to an embodiment of the present disclosure. The server 900 may have a relatively large difference due to configuration or performance, which may include one or more central processing units (central processing units, CPU) 922 (e.g., one or more processors), a storage 932, and one or more storage mediums 930 (e.g., one or more mass storage devices) with store an application program 942 or data 944. The storage 932 and the storage medium 930 may be transient storage or persistent storage. The program stored in the storage medium 930 may include one or more modules (not shown in the figures). Each module may include a series of instructions that operate on the server. Further, the CPU 922 may be configured to communicate with the storage medium 930, and execute a series of instructions in the storage medium 930 on the server 900.

The server 900 may also include one or more power supplies 926, one or more wired or wireless network interfaces 950, one or more input-output interfaces 958, and/or, one or more operating systems 941, such as Windows Server™, Mac OS X™, Unix™, Linux™, FreeBSD™, etc.

The execution flow of the embodiment method may be implemented based on the structure of the server.

It is noted that, in the embodiments of the data interworking device, the division of the units is only based on logical functions, which is not limited to the division, as long as the corresponding functions can be achieved in addition, specific names of functional units are only for distinguishing each other, and are not intended to limit the scope of the present disclosure.

It can be understood by those skilled in the art that all or some of steps in the methods according to the embodiments may be implemented by hardware being instructed by a program. The corresponding program may be stored in a computer-readable storage medium, which may be a read-only memory, a magnetic disk or an optical disk.

Specific implementations according to the present disclosure are described as above, but it cannot be understood as limiting the scope of the present disclosure. Those skilled in the art may easily conceive of variations or replacements, which fall within the scope of the present disclosure. Therefore, the scope of the present disclosure is defined with scopes of claims.

1. A data interworking method, comprising:
receiving first data and second data, wherein the first data are associated with a first user identity of a first platform, and the second data are associated with a second user identity of a second platform;
generating a unified user identity of a user corresponding to the first user identity and/or the second user identity in response to a request of the user, and obtaining result data corresponding to the unified user identity of the user according to the first data and the second data; and
storing the result data and the unified user identity.

2. The method according to claim 1, wherein the obtaining the result data corresponding to the unified user identity of the user according to the first data and the second data comprises:
determining the first data as the result data corresponding to the unified user identity of the user in a case that the first user identity corresponds to the user; and
determining the second data as the result data corresponding to the unified user identity of the user in a case that the second user identity corresponds to the user.

3. The method according to claim 1, wherein after storing the result data and the unified user identity, the method further comprises:
obtaining group account information, wherein the group account information comprises at least two user identities;
determining a unified user identity corresponding to each of user identities in the group account information, and determining result data corresponding to each of unified user identities; and
sorting the user identities in the group account information according to the result data corresponding to each of unified user identities.

4. The method according to claim 3, wherein, the determining result data corresponding to each of unified user identifies comprises:
obtaining the result data corresponding to each of unified user identities from a database according to the unified user identity corresponding to each of user identities.

5. The method according to claim 1, wherein after storing the result data and the unified user identity, the method further comprises:
receiving a query request, wherein the query request comprises the unified user identity, the first user identity, the second user identity or a type of the result data; and
querying a database storing the result data and the unified user identities according to the query request, and determining a query result.

6. The method according to claim 1, wherein the obtaining the result data corresponding to the unified user identity of the user according to the first data and the second data comprises:
taking a larger value of the first data and the second data as the result data corresponding to the unified user identity of the user, or taking a sum of the first data and the second data as the result data corresponding to the unified user identity of the user, in a case that the first user identity and the second user identity both correspond to the user.

7. The method according to claim 1, wherein before the obtaining the result data corresponding to the unified user identity of the user according to the first data and the second data, the method further comprises:
constructing a data structure, wherein data items of the data structure comprises at least one of: the unified user identity, a platform type, the first user identity, the second user identity, the first data, the second data, the result data, reporting time of the first data, reporting time of the second data and reporting time of the result data.

8. The method according to claim 1, wherein the storing the result data and the unified user identity comprises:
storing the result data and the unified user identity a distributed database every predetermined time period.

9. The method according to claim 1, wherein the receiving the first data and the second data comprises:
receiving a log of a user who is active in daily active users, wherein the log comprises the first data and the second data.

10. A data interworking device, comprising:
a memory; and
one or more processors,
wherein the memory stores program instructions, and the processor is configured to execute the program instructions to:
receive first data and second data, wherein the first data are associated with a first user identity of a first platform, the second data are associated with a second user identity of a second platform;
generate a unified user identity of a user corresponding to the first user identity and/or the second user identity in response to a request of the user, and obtain result data corresponding to the unified user identity of the user according to the first data and the second data; and
store the result data and the unified user identity.

11. The data interworking device according to claim 10, wherein the processor is further configured to:
determine the first data as the result data corresponding to the unified user identity of the user in a case that the first user identity corresponds to the user; and
determine the second data as the result data corresponding to the unified user identity of the user in a case that the second user identity corresponds to the user.

12. The data interworking device according to claim 10, wherein the processor is further configured to:
obtain group account information after storing the result data and the unified user identities, wherein the group account information comprises at least two user identities;
determine a unified user identity corresponding to each of user identities in the group account information, and determine result data corresponding to each of unified user identities; and
sort the user identities in the group account information according to the result data corresponding to each of unified user identities.

13. The data interworking device according to claim 12, wherein the processor is further configured to obtain the result data corresponding to each of unified user identities from a database according to the unified user identity corresponding to each of user identities.

14. The data interworking device according to claim 10, wherein the processor is further configured to:
receive a query request after storing the result data and the unified user identities, wherein the query request comprises the unified user identity, the first user identity, the second user identity or a type of the result data; and
query a database storing the result data and the unified user identities according to the query request, and determine a query result.

15. The data interworking device according to claim 10, wherein the processor is further configured to take a larger value of the first data and the second data as the result data corresponding to the unified user identity of the user, or take a SUM of the first data and the second data as the result data corresponding to the unified user identity of the user, in a case that the first user identity and the second user identity both correspond to the user.

16. The data interworking device according to claim 10, wherein the processor is further configured to:
construct a data structure before obtaining the result data corresponding to the unified user identity of the user according to the first data and the second data, wherein data items of the data structure comprises at least one of: the unified user identity, a platform type, the first user identity, the second user identity, the first data, the second data, the result data, reporting time of the first data, reporting time of the second data and reporting time of the result data.

17. The data interworking device according to claim 10, wherein the processor is further configured to store the result data and the unified user identity in a distributed database every predetermined time period.

18. The data interworking device according to claim 10, wherein the processor is further configured to receive a log of a user who is active in daily active users, wherein the log comprises the first data and the second data.

19. A non-transitory computer readable storage medium storing a plurality of programs, when executing by a processor to:
receive first data and second data, wherein the first data are associated with a first user identity of a first platform, the second data are associated with a second user identity of a second platform;
generate a unified user identity of a user corresponding to the first user identity and/or the second user identity in response to a request of the user, and obtain result data corresponding to the unified user identity of the user according to the first data and the second data; and
store the result data and the unified user identity.
